(19) United States
(12) Patent Application Publication
(10) Pub. No.: US 2024/0009498 A1
(43) Pub. Date: Jan. 11, 2024

(54) Fire Suppression Device And Method Of Use

(71) Applicant: Ed Schweitzer, Sun City West, AZ (US)

(72) Inventor: Ed Schweitzer, Sun City West, AZ (US)

(21) Appl. No.: 17/860,808

(22) Filed: Jul. 8, 2022

(51) Int. Cl. A62C 37/40; A62C 35/68; A62C 3/07

(52) U.S. Cl. CPC A62C 37/40; A62C 35/68; A62C 3/07

(57) ABSTRACT

A fire suppression device for an engine compartment of a vehicle includes a valve, which is normally closed and which is in fluidic communication with a sprinkler. The valve and the sprinkler are mountable within an engine compartment of a vehicle, with the valve being engaged to the vehicle's coolant pump. The valve's first terminal is attached to a positive post of the vehicle's battery. A linkage extending from the second terminal is connected to a common ground of the vehicle. The linkage is positioned into, through, or proximate to, a combustible item in the engine compartment. The linkage comprises a fusible or combustible element, so that, upon exposure to combustive conditions, the second terminal is electrically engaged to the common ground and the valve is actuated. Upon actuation of the valve, the coolant pump pumps coolant to the sprinkler to spray the coolant onto a fire in the engine compartment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR Not Applicable

### BACKGROUND OF THE INVENTION

### (1) Field of the Invention.

The disclosure relates to suppression devices and more particularly pertains to a new suppression device for an engine compartment of a vehicle. The present invention discloses a suppression device that utilizes coolant pumped by a coolant pump of a vehicle to a sprinkler to suppress a fire that occurs within the engine compartment.

(2) Description of Related Art including information disclosed under 37 CFR 1.97 and 1.98.

The prior art relates to suppression devices, which may comprise fire extinguishing fluids or gasses under pressure in combination with actuators and one or more of sensors and thermal fuses or fusible linkages. What is lacking in the prior art is a suppression device comprising a valve, which is normally closed and which is in fluidic communication with a sprinkler. Fluid is supplied to the valve by a vehicle's coolant pump. A linkage comprising twisted wires acts as a switch, with the valve being actuated upon combustion or melting of insulation surrounding the twisted wires. Upon actuation of the valve, the vehicle's coolant pump pumps coolant to the sprinkler to spray the coolant onto a fire.

### BRIEF SUMMARY OF THE INVENTION

An embodiment of the disclosure meets the needs presented above by generally comprising a valve, which is normally closed and which is in fluidic communication with a sprinkler. The valve and the sprinkler are configured to be mounted within an engine compartment of a vehicle. The valve is configured to be fluidically engaged to a coolant pump. A first terminal and a second terminal are operationally engaged to the valve. The first terminal is configured to be operationally engaged to a positive post of a battery of the vehicle. A linkage extends from the second terminal and is configured to operationally engage a common ground of the vehicle. The linkage is configured to be positioned into, through, or proximate to, a combustible item in the engine compartment. The linkage comprises a fusible or combustible element, so that, upon exposure to combustive conditions, the second terminal is electrically engaged to the common ground and the valve is actuated. Upon actuation of the valve, the coolant pump pumps coolant to the sprinkler, which is configured to spray the coolant onto a fire in the engine compartment to suppress the fire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a block diagram view of a fire suppression device according to an embodiment of the disclosure.

FIG. 2 is a block diagram view of an embodiment of the disclosure.

FIG. 3 is a detail view of an embodiment of the disclosure.

FIG. 4 is an in-use view of an embodiment of the disclosure.

FIG. 5 is a flow diagram for a method utilizing an embodiment of the disclosure.

### DETAILED DESCRIPTION OF THE INVENTION

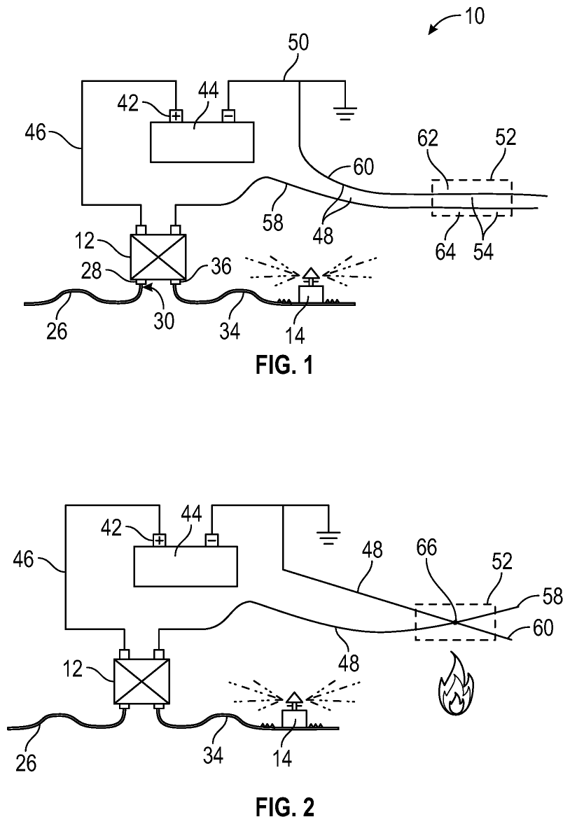

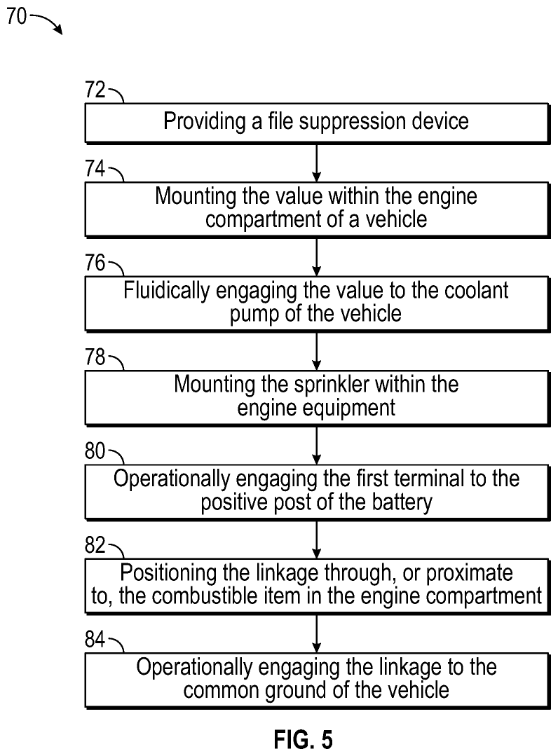

With reference now to the drawings, and in particular to FIGS. 1 through 5 thereof, a new suppression device embodying the principles and concepts of an embodiment of the disclosure and generally designated by the reference numeral 10 will be described.

As best illustrated in FIGS. 1 through 5, the fire suppression device 10 generally comprises a valve 12, which is normally closed and which is in fluidic communication with a sprinkler 14. The valve 12 and the sprinkler 14 are configured to be mounted within an engine compartment 16 of a vehicle 18. The valve 12 is configured to be fluidically engaged to a coolant pump 20 of the vehicle 18. The sprinkler 14 could be mounted, for example, to an underside 22 of a hood 24 of the vehicle 18. The present invention also anticipates multiple valve 12 and sprinkler 14 combinations, with the sprinklers 14 being positioned in various locations on the vehicle 18, such as, but not limited to, passenger compartments, cargo compartments, battery compartments of electric or hybrid vehicles, proximate to fuel tanks, and the like.

A first hose 26 is attached by its first end 28 to and extends from an inlet port 30 of the valve 12. A second end 32 of the first hose 26 is configured to be operationally engaged to the coolant pump 20 of the vehicle 18. For example, a T-connector (not shown) could be attached to the coolant pump 20 or spliced into a coolant hose (not shown) that extends from the coolant pump 20, providing a connection point for the first hose 26. A second hose 34 is attached to and extends between an outlet port 36 of the valve 12 and the sprinkler 14, thus fluidically engaging the sprinkler 14 to the valve 12.

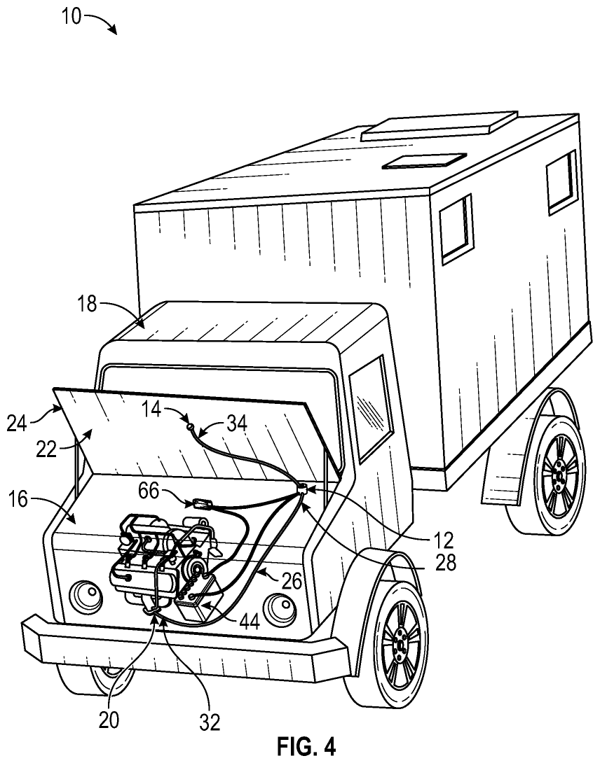

A first terminal 38 and a second terminal 40 are operationally engaged to the valve 12. The first terminal 38 is configured to be operationally engaged to a positive post 42 of a battery 44 of the vehicle 18. As shown in FIGS. 1 and 2, a first wire 46 is attached to and extends from the first terminal 38. The first wire 46 is configured to operationally engage the positive post 42 of the battery 44. A linkage 48 extends from the second terminal 40 and is configured to operationally engage a common ground 50 of the vehicle 18. The linkage 48 is configured to be positioned into, through, or proximate to, a combustible item 52 in the engine compartment 16, as shown in FIG. 4.

The linkage 48 comprises a fusible or combustible element 54, so that, upon exposure to combustive conditions, the second terminal 40 is electrically engaged to the common ground 50 and the valve 12 is actuated. Upon actuation of the valve 12, the coolant pump 20 pumps coolant 56 to the sprinkler 14, which is configured to spray the coolant 56 onto a fire in the engine compartment 16 to suppress the fire. The present invention is anticipated to be of particular use in suppressing fires in the engine compartments of recreational vehicles.

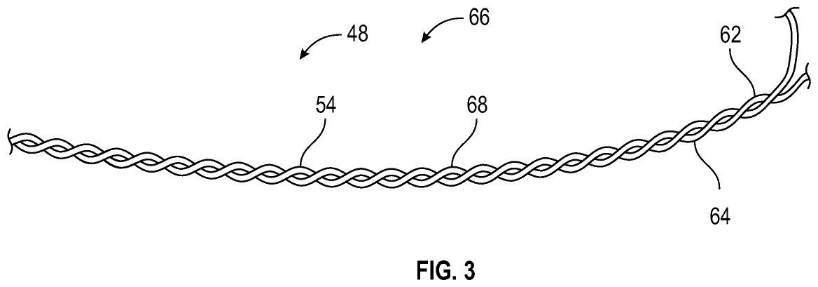

A shown in FIGS. 1 and 2, the linkage 48 comprises a second wire 58 and a third wire 60. The second wire 58 is attached to and extends from the second terminal 40. The third wire 60 has a first segment 62, which is twisted with a section 64 of the second wire 58 so that the first segment 62 of third wire 60 and the section 64 of the second wire 58 define a switch 66, as shown in FIG. 3. The switch 66 is configured to be positioned into, through, or proximate to the combustible item 52. In this configuration, the fusible or combustible element 54 comprises insulation 68, which is positioned around one or both of the second wire 58 and the third wire 60 so that the second wire 58 is electrically insulated from the third wire 60. The present invention also anticipates multiple linkages 48, which extend into, through, or proximate to multiple combustible items 52 throughout the engine compartment 16 as well as other parts of the vehicle 18. The fire suppression device 10 also could include additional wiring (not shown) so that the coolant pump 20 is actuated concurrently with the valve 12 even when the vehicle 18 is not running.

In use, the fire suppression device 10 enables a method of suppressing a fire in an engine compartment of a vehicle 70. The method 70 comprises a first step 72 of providing a fire suppression device 10 according to the specification above. A second step 74 of the method 70 is mounting the valve 12 within the engine compartment 16 of a vehicle 18. A third step 76 of the method 70 is fluidically engaging the valve 12 to the coolant pump 20 of the vehicle 18. A fourth step 78 of the method 70 is mounting the sprinkler 14 within the engine compartment 16. A fifth step 80 of the method 70 is operationally engaging the first terminal 38 to the positive post 42 of the battery 44. A sixth step 82 of the method 70 is positioning the linkage 48 extending from the second terminal 40 into, through, or proximate to, the combustible item 52 in the engine compartment 16. A seventh step 84 of the method 70 is operationally engaging the linkage 48 to the common ground 50 of the vehicle 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire suppression device comprising:
a valve, the valve being normally closed and configured for mounting within an engine compartment of a vehicle and for being fluidically engaged to a coolant pump of the vehicle;
a sprinkler configured to be mounted within the engine compartment, the sprinkler being in fluidic communication with the valve;
a first terminal and a second terminal operationally engaged to the valve, the first terminal being configured for operationally engaging a positive post of a battery of the vehicle; and
a linkage extending from the second terminal and being configured for operationally engaging a common ground of the vehicle, the linkage being configured for positioning into, through, or proximate to, a combustible item in the engine compartment, the linkage comprising a fusible or combustible element, such that, upon exposure to combustive conditions, the second terminal is electrically engaged to the common ground and the valve is actuated, such that the coolant pump pumps coolant to the sprinkler, wherein the sprinkler is configured for spraying coolant onto a fire in the engine compartment to suppress the fire.

2. The fire suppression device of claim 1, further including:
a first hose attached by a first end to and extending from an inlet port of the valve, the first hose having a second end configured to be operationally engaged to the coolant pump of the vehicle; and
a second hose attached to and extending between an outlet port of the valve and the sprinkler.

3. The fire suppression device of claim 1, further including a first wire attached to and extending from the first terminal, the first wire being configured for operationally engaging the positive post of the battery.

4. The fire suppression device of claim 3, wherein the linkage comprises:
a second wire attached to and extending from the second terminal;
a third wire having a first segment twisted with a section of the second wire, such that the first segment of third wire and the section of the second wire define a switch, wherein the switch is configured for positioning into, through, or proximate to the combustible item; and
the fusible or combustible element comprising insulation positioned around one or both of the second wire and the third wire, such that the second wire is electrically insulated from the third wire.

5. The fire suppression device of claim 1, further including:
a first hose attached by a first end to and extending from an inlet port of the valve, the first hose having a second end configured to be operationally engaged to the coolant pump of the vehicle;
a second hose attached to and extending between an outlet port of the valve and the sprinkler;
a first wire attached to and extending from the first terminal, the first wire being configured for operationally engaging the positive post of the battery;
the linkage comprising:
a second wire attached to and extending from the second terminal,
a third wire having a first segment twisted with a section of the second wire, such that the first segment of third wire and the section of the second wire define a switch, wherein the switch is configured for positioning into, through, or proximate to the combustible item, and
the fusible or combustible element comprising insulation positioned around one or both of the second wire and the third wire, such that the second wire is electrically insulated from the third wire.

6. A fire suppression system comprising:
a vehicle;
a valve, the valve being normally closed and mount within an engine compartment of the vehicle, the valve being fluidically engaged to a coolant pump of the vehicle;
a sprinkler mounted within the engine compartment, the sprinkler being in fluidic communication with the valve;
a first terminal and a second terminal operationally engaged to the valve, the first terminal being operationally engaged to a positive post of a battery of the vehicle; and
a linkage extending from the second terminal and operationally engaged to a common ground of the vehicle, the linkage being positioned into, through, or proximate to, a combustible item in the engine compartment, the linkage comprising a fusible or combustible element, such that, upon exposure to combustive conditions, the second terminal is electrically engaged to the common ground and the valve is actuated, such that the coolant pump pumps coolant to the sprinkler, wherein the sprinkler is configured for spraying coolant onto a fire in the engine compartment to suppress the fire.

7. The fire suppression system of claim 6, further including:
a first hose attached by a first end to and extending from an inlet port of the valve, the first hose having a second end operationally engaged to the coolant pump of the vehicle; and
a second hose attached to and extending between an outlet port of the valve and the sprinkler.

8. The fire suppression system of claim 6, further including a first wire attached to and extending between the first terminal and the positive post of the battery.

9. The fire suppression system of claim 8, further including:
the linkage comprising:
a second wire attached to and extending from the second terminal, and
a third wire having a first segment twisted with a section of the second wire, such that the first segment of third wire and the section of the second wire define a switch, the switch being positioned into, through, or proximate to the combustible item; and
the fusible or combustible element comprising insulation positioned around one or both of the second wire and the third wire, such that the second wire is electrically insulated from the third wire.

10. A method of suppressing a fire in an engine compartment of a vehicle using a fire suppression device, the method comprising the steps of:
providing a fire suppression device comprising:
a valve, the valve being normally closed and configured for mounting within an engine compartment of a vehicle and for being fluidically engaged to a coolant pump of the vehicle,
a sprinkler configured to be mounted within the engine compartment, the sprinkler being in fluidic communication with the valve,
a first terminal and a second terminal operationally engaged to the valve, the first terminal being configured for operationally engaging a positive post of a battery of the vehicle, and
a linkage extending from the second terminal and being configured for operationally engaging a common ground of the vehicle, the linkage being configured for positioning into, through, or proximate to, a combustible item in the engine compartment, the linkage comprising a fusible or combustible element, such that, upon exposure to combustive conditions, the second terminal is electrically engaged to the common ground and the valve is actuated, such that the coolant pump pumps coolant to the sprinkler, wherein the sprinkler is configured for spraying coolant onto a fire in the engine compartment to suppress the fire;
mounting the valve within the engine compartment of a vehicle;
fluidically engaging the valve to the coolant pump of the vehicle;
mounting the sprinkler within the engine compartment;
operationally engaging the first terminal to the positive post of the battery;
positioning the linkage extending from the second terminal into, through, or proximate to, the combustible item in the engine compartment; and
operationally engaging the linkage to the common ground of the vehicle.

11. The method of claim 10, further including:
a first hose attached by a first end to and extending from an inlet port of the valve, the first hose, a second end of the first hose being configured to be operationally engaged to the coolant pump of the vehicle; and
the step of fluidically engaging the valve to the coolant pump of the vehicle entails attachment of the second end of the first hose to the coolant pump or a coolant hose extending from the coolant pump.

12. The method of claim 10, further including:
a first wire attached to and extending from the first terminal, the first wire being configured for operationally engaging the positive post of the battery; and
the step of operationally engaging the first terminal to the positive post of the battery entails connecting the first wire to the positive post.

13. The method of claim 12, wherein the linkage comprises:
a second wire attached to and extending from the second terminal;
a third wire having a first segment twisted with a section of the second wire, such that the first segment of third wire and the section of the second wire define a switch, wherein the switch is configured for positioning into, through, or proximate to the combustible item; and
the fusible or combustible element comprising insulation positioned around one or both of the second wire and the third wire, such that the second wire is electrically insulated from the third wire.
